(19) United States
(12) Patent Application Publication
(10) Pub. No.: US 2021/0285786 A1
(43) Pub. Date: Sep. 16, 2021

(54) INFORMATION PROCESSING APPARATUS, NON-TRANSITORY STORAGE MEDIUM, AND SYSTEM

(71) Applicant: TOYOTA JIDOSHA KABUSHIKI KAISHA, Toyota-shi (JP)

(72) Inventors: Nozomi KANEKO, Nagoya-shi (JP); Aya ONODERA, Nagoya-shi (JP); Yuki TATSUMOTO, Nagoya-shi (JP); Tsuyoshi TAKENAMI, Nagoya-shi (JP)

(73) Assignee: TOYOTA JIDOSHA KABUSHIKI KAISHA, Toyota-shi (JP)

(21) Appl. No.: 17/189,875

(22) Filed: Mar. 2, 2021

(30) Foreign Application Priority Data
Mar. 11, 2020 (JP) 2020-042039

(51) Int. Cl. G01C 21/36; G06Q 50/00

(52) U.S. Cl. CPC G01C 21/3676; G06Q 50/01; G01C 21/3605; G01C 21/367

(57) ABSTRACT

A control unit is provided which is configured to perform: obtaining information on a place having a degree of popularity equal to or greater than a predetermined threshold in a social networking service; and transmitting, to a vehicle in which a first user gets, a command to display the place having a degree of popularity equal to or greater than the predetermined threshold value on a map displayed on a display of the vehicle.

### CROSS REFERENCE TO THE RELATED APPLICATION

This application claims the benefit of Japanese Patent Application No. 2020-042039, filed on Mar. 11, 2020, which is hereby incorporated by reference herein in its entirety.

### BACKGROUND

### Technical Field

The present disclosure relates to an information processing apparatus, a non-transitory storage medium, and a system.

### Description of the Related Art

There has been known a system that creates a shop list of souvenir shops according to their popularity and displays it on a screen of a display device, and then designates one of the souvenir shops in the shop list as a destination or a transit point (for example, see Patent Literature 1).

### CITATION LIST

### Patent Literature

Patent Literature 1: Japanese Patent Application Laid-Open Publication No. 2009-168567

### SUMMARY

When a user passes near a popular place in a social networking service (hereinafter, also referred to as an SNS), he or she may pass the place without noticing it. An object of the present disclosure is to allow a user to recognize a place or location popular in an SNS.

One aspect of the present disclosure is directed to an information processing apparatus including a control unit configured to perform:

obtaining information on a place having a degree of popularity equal to or greater than a predetermined threshold value in a social networking service; and

transmitting, to a vehicle in which a first user gets, a command to display the place having a degree of popularity equal to or greater than the predetermined threshold value on a map displayed on a display of the vehicle.

Another aspect of the present disclosure is directed to a non-transitory storage medium with a program stored therein, the program being configured to cause a computer to perform:

obtaining information on a place having a degree of popularity equal to or greater than a predetermined threshold value in a social networking service; and

transmitting, to a vehicle in which a first user gets, a command to display the place having a degree of popularity equal to or greater than the predetermined threshold value on a map displayed on a display of the vehicle.

In addition, a further aspect of the present disclosure is a program stored in a non-transitory storage medium, or an information processing method that is performed by a computer according to the program.

A still further aspect of the present disclosure is directed to a system comprising:

a vehicle in which a first user gets, the vehicle including a display capable of displaying a map; and

a server including a control unit configured to perform:

obtaining information on a place having a degree of popularity equal to or greater than a predetermined threshold value in a social networking service; and

transmitting, to the vehicle, a command to display the place having a degree of popularity equal to or greater than the predetermined threshold value on the map displayed on the display.

According to the present disclosure, it is possible to allow a user to recognize a place that is popular in an SNS.

### BRIEF DESCRIPTION OF THE DRAWINGS

FIG. 1 is a view illustrating a schematic configuration of a system according to an embodiment;

FIG. 2 is a block diagram schematically illustrating an example of a configuration of each of an in-vehicle device, a user terminal and a center server and an SNS server, which together constitute a system according to the embodiment;

FIG. 3 is a view illustrating an example of a functional configuration of the center server;

FIG. 4 is a view illustrating an example of a table configuration of first user information;

FIG. 5 is a view illustrating an example of a table configuration of SNS information;

FIG. 6 is a view illustrating an example of a functional configuration of the user terminal;

FIG. 7 is a view illustrating an example of a functional configuration of the in-vehicle device;

FIG. 8 is a flowchart of provision processing according to the embodiment;

FIG. 9 is a flowchart of the processing of a first user management unit according to the embodiment;

FIG. 10 is a flowchart of the processing of a navigation unit according to the embodiment;

FIG. 11 is a flowchart of the processing of an SNS account transmission unit according to the embodiment;

FIG. 12 is a sequence diagram illustrating the overall processing of the system; and

FIG. 13 is a view illustrating an example of a map displayed on a display of the in-vehicle device.

### DESCRIPTION OF THE EMBODIMENTS

A control unit included in an information processing apparatus, which is one aspect of the present disclosure, obtains information on a place or location having a degree of popularity equal to or greater than a predetermined threshold value in a social networking service (SNS). In addition, the control unit transmits, to a vehicle in which a first user gets, a command to display the place having a degree of popularity equal to or greater than the predetermined threshold value on a map displayed on a display of the vehicle. The first user may be a user who uses the SNS or a user who does not use the SNS. The degree of popularity may be, for example, the number of posts or the number of positive reactions recorded. The threshold value is a number with which the place can be said to be popular in the SNS. The place having a degree of popularity equal to or greater than the predetermined threshold value is a place or spot that can be said to be popular in the SNS, and is, for example, a place for which a first predetermined number or more of positive reactions have been recorded or a place for which a second predetermined number or more of posts have been made. The users who have shown a positive reaction in the SNS or the users who have posted to the SNS are a plurality of users who use the SNS, and may include the first user. A positive reaction means, for example, that, a social button is pressed. This includes, for example, pressing a “like” button, entering the number of stars, entering a score, or the like. The first predetermined number or the second predetermined number is a number that can be treated as popular, and can be determined by the first user or an administrator who manages the information processing apparatus. A post or posting can include characters, audio, or image. In addition, the post can include information related to a description of a place for which the posting is made, a comment or impression on a place for which the posting is made, or the like. The information on the place having a degree of popularity equal to or greater than the predetermined threshold value is information capable of specifying the place, and is, for example, position information, image data of the place, characters explaining the place, audio data explaining the place, or the like. Hereinafter, the place having a degree of popularity equal to or greater than the predetermined threshold value in the SNS is also referred to as a “popular posting place”. Here, note that the SNS may be an SNS used by the first user, an SNS designated by the first user, or an SNS designated by the administrator who manages the information processing apparatus.

In addition, the control unit transmits, to the vehicle in which the first user gets, a command to display the place having a degree of popularity equal to or greater than the predetermined threshold value on a map displayed on a display of the vehicle. The display that displays the map is, for example, a display included in a navigation system. The map displayed on the display may include route guidance. By the transmission of the command to display the popular posting place to the vehicle, the popular posting place is displayed on the map that is displayed on the display. Therefore, the first user can know, on the map, the place having a degree of popularity equal to or greater than the predetermined threshold value in the SNS.

Hereinafter, embodiments of the present disclosure will be described with reference to the accompanying drawings. The configurations of the following embodiments are some examples, and the present disclosure is not limited to the configurations of the embodiments. The following embodiments can be combined with one another as long as they do not conflict with one another.

### First Embodiment

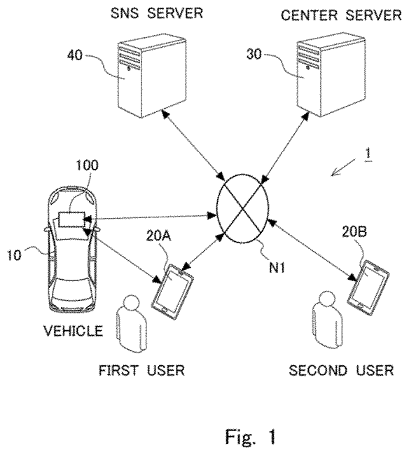

FIG. 1 is a view illustrating a schematic configuration of a system 1 according to a first embodiment of the present disclosure. The system 1 displays a place or spot, which is popular in an SNS (i.e., a popular posting place), on an in-vehicle device 300 of a vehicle 10 in which a first user is riding. The in-vehicle device 100 includes, for example, a navigation system. The popular posting place is, for example, a place or spot related to a post for which a social button has been pressed by a first predetermined number or more of second users, or a place or spot for which posts have been made by a second predetermined number or more of second users. The first user carries a first user terminal 20A. The second users each carry a second user terminal 20B. The second users are users using the SNS. Here, note that in the following, in cases where the first user terminal 20A and the second user terminals 20B are not distinguished from each other, they are simply referred to as user terminals 20. In addition, in cases where the first user and the second users are not distinguished from each other, they are also simply referred to as users. A user terminal 20 is a terminal capable of posting to the SNS, pressing a social button for a post to the SNS, and browsing the SNS. Also, note that a user who has posted at the popular posting place or a user who has pressed the social button to a post about the popular posting place can include the first user.

In an example of FIG. 1, the system 1 includes the in-vehicle device 100 mounted in the vehicle 10, the first user terminal 20A, a second user terminal 20B, a center server 30, and an SNS server 40. The in-vehicle device 100, the first user terminal 20A, the second user terminal 20B, the center server 30, and the SNS server 40 are connected to one another by a network N1. Here, note that the network N1 is, for example, a global public communication network such as the Internet, but a wide area network (WAN) or other communication networks may be employed. In addition, the network N1 may include a telephone communication network such as a mobile phone network and a wireless communication network such as a Wi-Fi (registered trademark) network. The in-vehicle device 100 and the first user terminal 20A are connected to each other by short-range wireless communication such as Bluetooth (registered trademark). Here, note that FIG. 1 illustrates two user terminals 20 by way of example, but user terminals 20 are possessed or carried by a plurality of users, respectively, and there are as many user terminals 20 as there are users. In addition, FIG. 1 illustrates one vehicle 10 by way of example, but there may be a plurality of vehicles 10.

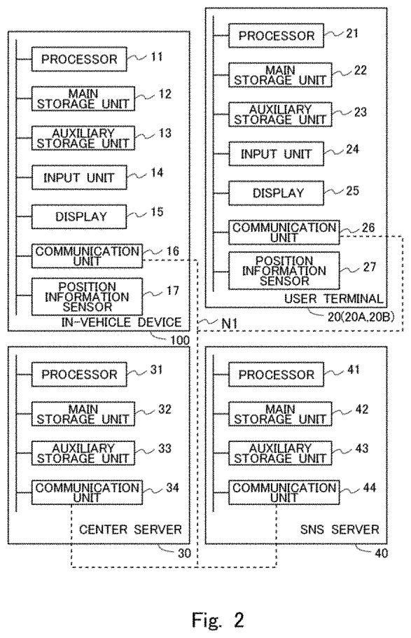

The hardware configurations and functional configurations of the in-vehicle device 100, the user terminal 20, the center server 30, and the SNS server 40 will be described based on FIG. 2. FIG. 2 is a block diagram schematically illustrating one example of the configuration of each of the in-vehicle device 100, the user terminal 20, the center server 30 and the SNS server 40, which together constitute the system 1 according to the present embodiment.

The center server 30 has a configuration of a general computer. The center server 30 includes a processor 31, a main storage unit 32, an auxiliary storage unit 33, and a communication unit 34. These components are connected to one another by a bus.

The processor 31 is a central processing unit (CPU), a digital signal processor (DSP), or the like. The processor 31 controls the center server 30, thereby performing various information processing operations. The processor 31 is an example of a control unit. The main storage unit 32 is a random access memory (RAM), a read only memory (ROM), or the like. The auxiliary storage unit 33 is an erasable programmable ROM (EPROM), a hard disk drive (HDD), a removable medium, or the like. The auxiliary storage unit 33 stores therein an operating system (OS), various kinds of programs, various kinds of tables, and the like. The processor 31 loads a program stored in the auxiliary storage unit 33 into a work area of the main storage unit 32 and executes the program, so that each component unit or the like is controlled through the execution of the program. Thus, the center server 30 realizes functions matching predetermined purposes, respectively. The main storage unit 32 and the auxiliary storage unit 33 are computer readable recording media. Here, note that the center server 30 may be a single computer or a combination of a plurality of computers. In addition, the information stored in the auxiliary storage unit 33 may be stored in the main storage unit 32. Also, the information stored in the main storage unit 32 may be stored in the auxiliary storage unit 33.

The communication unit 24 is a means or unit that communicates with the in-vehicle device 100, the user terminals 20, and the SNS server 40 via the network N1. The communication unit 34 is, for example, a local area network (LAN) interface board, or a radio or wireless communication circuit for radio or wireless communication. The LAN interface board and the radio or wireless communication circuit are connected to the network N1.

Here, note that a series of processing performed by the center sever 30 can be performed by hardware, but can also be performed by software.

The SNS server 40 has a configuration of a general computer. The SNS server 40 includes a processor 41, a main storage unit 42, an auxiliary storage unit 43, and a communication unit 44. These components are connected to one another by a bus. The processor 41, the main storage unit 42, the auxiliary storage unit 43, and the communication unit 44 are the same as the processor 31, the main storage unit 32, the auxiliary storage unit 33, and the communication unit 34 of the center server 30, respectively, and hence, the description thereof will be omitted.

Next, a user terminal 20 will be described. The user terminal 20 is, for example, a small computer such as a smart phone, a mobile phone, a tablet terminal, a personal information terminal, a wearable computer (a smart watch or the like), or a personal computer (PC). The user terminal 20 includes a processor 21, a main storage unit 22, an auxiliary storage unit 23, an input unit 24, a display 25, a communication unit 26, and a position information sensor 27. These components are connected to one another by a bus. The processor 21, the main storage unit 22 and the auxiliary storage unit 23 are the same as the processor 31, the main storage unit 32 and the auxiliary storage unit 33 of the center server 30, respectively, and hence, the description thereof will be omitted.

The input unit 24 is a means or unit that receiver an input operation performed by a user, and is, for example, a touch panel, a mouse, a keyboard, a push button, or the like. The display 25 is a means or unit that, presents information to the user, and is, for example, a liquid crystal display (LCD), an electroluminescence (EL) panel, or the like. The input unit 24 and the display 25 may be configured as a single touch panel display. The communication unit 26 is a communication means or unit for connecting the user terminal 20 to the network N1. The communication unit 26 is a circuit for communicating with other devices (e.g., the in-vehicle device 100, the center server 30 or the like) via the network N1 by making use of a mobile communication service (e.g., a telephone communication network such as 5G (5th Generation), 4G (4th Generation), 3G (3rd Generation), or LTE (Long Term Evolution)) or a wireless communication network such as Wi-Fi (registered trademark), Bluetooth (registered trademark) or the like.

The position information sensor 27 obtains position information (e.g., latitude and longitude) of the user terminal 20. The position information sensor 27 is, for example, a GPS (Global Positioning System) receiver unit, a wireless LAN communication unit, or the like. The position information obtained by the position information sensor 27 is transmitted to the SNS server 40 at the time when the user submits a post to the SNS.

Then, the in-vehicle device 100 of the vehicle 10 will be described. The user terminal 100 includes a processor 11, a main storage unit 12, an auxiliary storage unit 13, an input unit 14, a display 15, a communication unit 16, and a position information sensor 17. These components are connected to one another by a bus. The processor 11, the main storage unit 12, the auxiliary storage unit 13, the input unit 14, the display 15, and the communication unit 16 are the same as the processor 21, the main storage unit 22, the auxiliary storage unit 23, the input unit 24, the display 25, and the communication unit 26 of the user terminal 20, and hence, the description thereof will be omitted.

The position information sensor 17 obtains position information (e.g., latitude and longitude) of the vehicle 10 at a predetermined period. The position information sensor 17 is, for example, a GPS (Global Positioning System) receiver unit, a wireless LAN communication unit, or the like. The information obtained by the position information sensor 17 is recorded, for example, in the auxiliary storage unit 13 or the like, and transmitted to the center server 30.

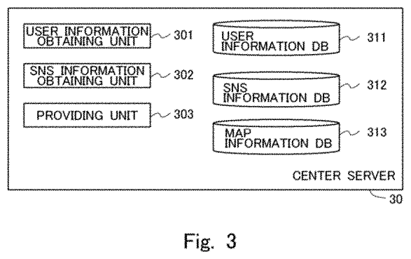

Now, the function of the center server 30 will be described. FIG. 3 is a view illustrating an example of a functional configuration of the center server 30. The center server 30 includes, as its functional components, a user information obtaining unit 301, an SNS information obtaining unit 302, a providing unit 303, a user information DB 311, an SNS information DB 312, and a map information DB 313. The processor 31 of the center server 30 executes the processing of the user information obtaining unit 301, the SNS information obtaining unit 302, and the providing unit 303 by means of a computer program on the main storage unit 32. However, any of the functional components or a part of the processing thereof may be performed by a hardware circuit.

The user information DB 311, the SNS information DB 312, and the map information DB 313 are constructed by a program of a database management system (DBMS) that is executed by the processor 31 to manage data stored in the auxiliary storage unit 33. The user information DB 311, the SNS information DB 312 and the map information DB 313 are, for example, relational databases.

Here, note that any of the functional components of the center server 30 or a part of the processing thereof may be performed by another computer connected to the network N1.

The user information obtaining unit 301 obtains information of the first user who makes use of the system 1 (hereinafter, also referred to as first user information). The first user information is information that is used to notify the first user driving the vehicle 10 of the popular posting place. The first user information includes information on a first user ID which is an identifier unique to the first user, a vehicle ID which is an identifier unique to the vehicle 10, a current location of the vehicle 10, and an SNS account of the first user. For example, as will be described later, the in-vehicle device 100 specifies the first user ID of the first user who is driving the vehicle 10 and the SNS account of the first user, by performing short-range wireless communication between the in-vehicle device 100 and the first user terminal 20A. In addition, the user information obtaining unit 301 obtains position information of the vehicle 10 detected by the position information sensor 17. The position information is information transmitted from the in-vehicle device 100 to the center server 30, and includes information on the current location of the vehicle 10.

Then, the first user information is transmitted from the in-vehicle device 100 to the center server 30. Here, note that as another method, the first user information may be transmitted from the first user terminal 20A to the center server 30. The current location in this case may be obtained from the position information sensor 27 of the user terminal 20. Further, as another method, the relation between the first user ID, the vehicle ID, and the SNS account of the first user may have been registered in the center server 30 in advance by the first user using the first user terminal 20A. In the present embodiment, the SNS account has been associated with the first user ID, but instead of this, the SNS account may have been associated with the vehicle ID. Upon obtaining the first user information, the user information obtaining unit 301 stores the first user information in the user information DB 311 to be described later.

The SNS information obtaining unit 302 obtains, from the SNS server 40, information on a place popular with second users (hereinafter, also referred to as SNS information). The SNS information includes at least information (e.g., position information, image information, or a description of the place included in the post) necessary for specifying the popular posting place, and further includes the number of second users who have posted the popular posting place or the number of the second users who have shown a positive reaction to the post in the popular posting place. In addition, the SNS information may include an SNS account of a second user who has first posted the popular posting place and information associated with the SNS account (e.g., an icon representing the second user or the like). The popular posting place is, for example, a place which has been posted by a second user and for which it is recorded that the first predetermined number or more of second users have shown a positive reaction, or a place which has been posted by the second predetermined number or more of second users.

The positive reaction includes an action of a second user pressing the social button (e.g., pressing a like button or entering the number of stars) for the post, or entering some characters (e.g., a rating or score) for the post, etc. Here, note that the SNS information obtained by the SNS information obtaining unit 302 may be limited to, for example, information on popular posting places included in a predetermined area from the current location of the vehicle 10 that provides information or the popular posting place. The predetermined area may be, for example, an area that can be displayed on a map of the in-vehicle device 100. In this case, popular posting places within a predetermined distance from the current location of the vehicle 10 may be set as the popular posting places included in the predetermined area. The predetermined area or the predetermined distance may be a range within which the first user can move with the vehicle 10. In addition, a moving route may be obtained from the vehicle 10, so that information on popular posting places included in a predetermined area from the moving route may be obtained.

In addition, the information on popular posting places may include information such as names of buildings, names of shops or stores, names of sightseeing spots, coordinates (e.g., latitude and longitude), or an explanation about the places. These pieces of information are, for example, information for providing location or position information about the popular posting places or explaining what the popular posting places are like to the first user. Upon obtaining the SNS information, the SNS information obtaining unit 302 stores the SNS information in the SNS information DB 312 which will be described later.

Here, note that the SNS information obtaining unit 302 may obtain SNS information in the SNS used by the first user, or may obtain SNS information in a predetermined SNS regardless of whether the first user uses this SNS, or may obtain SNS information in an SNS designated by the first user regardless of whether the first user uses this SNS. Therefore, there may be a plurality of SNS servers 40 corresponding to the SNSes used by the first user, respectively. For example, even if the first user is a user who does not use an SNS, the SNS information obtaining unit 302 can obtain SNS information from the SNS servers 40.

The providing unit 303 transmits, to the in-vehicle device 100, an instruction or command to display the popular posting places on the map. The providing unit 303 accesses the SNS information DB 312, and transmits SNS information to the in-vehicle device 100 of the vehicle 10 associated with the first user. Here, note that the information to be transmitted to the vehicle 10 may be limited to, for example, information on places where posting places or locations are included in the predetermined area from the current location of the vehicle 10. The information to fee transmitted to the in-vehicle device 100 includes position information of a popular posting place, the number of second users who have posted or the number of second users who have pressed the social button, an SNS account of a second user, an icon representing the second user, and the like. The SNS account of the second user may be, for example, an SNS account of a second user who has first posted the popular posting place. The icon representing the second user is, for example, an icon corresponding to the SNS account of the second user who has first posted the popular posting place. An image or the like indicating the second user can be used as the icon. Here, note that the SNS account of the second user may be randomly selected from among the second users who have posted the popular posting place.

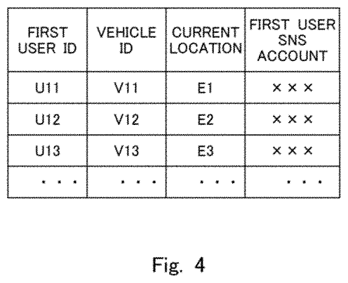

Here, the configuration of the first user information stored in the user information DB 311 will be described based on FIG. 4. FIG. 4 is a view illustrating an example of a table configuration of the first user information. The first user information table includes individual fields of first user ID, vehicle ID, current location, and first user SNS account. Identification information (user ID) for specifying the first user is entered in the first user ID field. Identification information (vehicle ID) for specifying the vehicle 10 driven by the first user is entered in the vehicle ID field. Information on the current location of the vehicle 10 is entered in the current location field. The information on the current location of the vehicle 10 is the position information detected by the position information sensor 17 of the in-vehicle device 100, and is provided from the in-vehicle device 100. Here, note that in the current location field, information on the current location of the first user terminal 20A transmitted from the first user terminal 20A may be entered. In the first user SNS account field, information on the SNS account of the first user is entered.

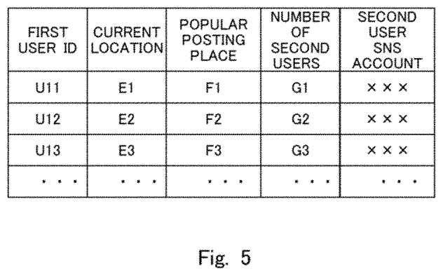

Next, the configuration of the SNS information stored in the SNS information DB 312 will be described based on FIG. 5. FIG. 5 is a view illustrating an example of a table configuration of the SNS information. The SNS information table includes individual fields of first user ID, current location, popular posting place, the number of second users, and second user SNS account. Identification information for specifying the first user is entered in the first user ID field. Information on the current location of the vehicle 10 is entered in the current location field. The vehicle 10 is a vehicle associated with the first user in the user information DB 311. Here, note that in the current location field, information on the current location of the first user terminal 20A transmitted from the first user terminal 20A may be entered. In the popular posting place field, information on a popular posting place is entered. The information on the popular posting place includes, for example, position information detected by the position information sensor 27 of a second user terminal 20B at the time when a second user posts to the SNS. Here, note that the popular posting place field may be limited to, for example, information on popular posting places included in the predetermined area from the current location of the vehicle 10. In cases where a plurality of popular posting places are included in the predetermined area, a record for each popular posting place is created. In the second user number field, for example, the number of second users who have posted a popular posting place or the number of second users who have pressed a social button for the post of a popular posting place is entered. In the second user SNS account field, for example, information on the SNS account of the second user who has first posted the popular posting place is entered. Here, note that in the second user SNS account field, an icon associated with the SNS account of the second user who has first posted the popular posting place may be entered. Information on each of the popular posting place, the number of second users, and the second user SNS account is provided from the SNS server 40.

In the map information DB 313, map data and map information including POI (Point of Interest) information such as characters, photographs or the like representing characteristics or features of each point on the map data are entered. Here, note that the map information DB 111 may be provided from another system connected to the network N1, e.g., a GIS (Geographic Information System).

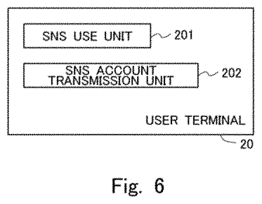

Then, the function of the user terminal 20 will be described. FIG. 6 is a view illustrating an example of a functional configuration of the user terminal 20. The user terminal 20 includes, as its functional components, an SNS use unit 201 and an SNS account transmission unit 202. The processor 21 of the user terminal 20 executes the processing of the SNS use unit 201 and the SNS account transmission unit 202 by means of a computer program on the main storage unit 22. However, the SNS use unit 201, the SNS account transmission unit 202, or a part of the processing thereof may be performed by a hardware circuit.

The SNS use unit 201 can apply for SNS use registration to the SNS server 40. At this time, the SNS use unit 201 transmits information on the SNS account and the icon of the user to the SNS server 40 according to an input of the user. In addition, the SNS use unit 201 displays an operation screen on the display 25, and transmits to the SNS server 40 information corresponding to the input to the input unit 24 by the user. For example, the SNS use unit 201 displays the operation screen or the like for the SNS on a touch panel display, and, in cases where the user performs some input on the operation screen or the like, transmits information corresponding to the input to the SNS server 40. For example, an SNS post and a social button (e.g., a like button) are displayed on the touch panel display, and in cases where the user selects (e.g., taps) the social button, information indicating the selection is transmitted to the SNS server 410. In addition, for example, when a post to the SNS is inputted to the user terminal 20, information on the post is transmitted to the SNS server 40. The post can include image data or audio data. Further, the post can include position information obtained by the position information sensor 27.

The SNS account transmission unit 202 transmits the first user ID and the SNS account of the first user to the in-vehicle device 100 by short-range wireless communication. The SNS account transmission unit 202 transmits the first user ID and the SNS account of the first user stored in the auxiliary storage unit 23 to the in-vehicle device 100. Here, note that the SNS account of the first user may be received from an SNS application executed in the first user terminal 20A.

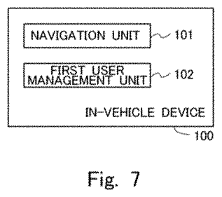

Now, the function of the in-vehicle device 100 of the vehicle 10 will be described. FIG. 7 is a view illustrating an example of a functional configuration of the in-vehicle device 100. The in-vehicle device 100 includes, as its functional components, a navigation unit 101 and a first user management unit 102. The processor 11 of the in-vehicle device 100 executes the processing of the navigation unit 101 and the first user management unit 102 by means of a computer program on the main storage unit 12. However, the navigation unit 101, the first user management unit 102, or a part of the processing thereof may be performed by a hardware circuit.

The navigation unit 101 displays a map around the current location of the vehicle 10 based on the map information stored in the auxiliary storage unit 13. The map information stored in the auxiliary storage unit 13 is equivalent to the map information stored in the map information DB 313 of the center server 30. In addition, the navigation unit 101 generates a moving route of the vehicle 10 baaed on the current location and a destination inputted by the first user via the input unit 14, and guides the moving route to the first user. A known technique can be used to generate this moving route. For example, the navigation unit 101 displays the map and the moving route on the display 15, and guides a moving direction by voice.

In addition, upon receiving a command to display a popular posting place on a map transmitted from the center server 30, the navigation unit 301 displays the popular posting place on the map displayed on the display 15 based on the SNS information included in the command. When the popular posting place is displayed on the map, the navigation unit 101 displays, for example, a thumbnail of an image photographed at the popular posting place, or an account, icon, avatar or the like of the second user who has first posted, thereby indicating the position of the popular posting place. These pieces of information are transmitted from the center server 30. Also, in cases where the popular posting place displayed on the display 15 is tapped by the first user, the navigation unit 101 may display, on the display 15, an image or posting content corresponding to the popular posting place.

The first user management unit 102 obtains the first user ID and the SNS account of the first user from the first user terminal 20A, obtains the current location of the vehicle 10 from the position, information sensor 17, and transmits the first user ID, the SNS account, and the current location to the center server 30 together with the vehicle ID. The first user management unit 102 obtains the first user ID and the SNS account by performing short-range wireless communication with the first user terminal 20A by means of the communication unit 16. Here, note that the current location of the vehicle 10 is the same as the current location of the first user terminal 20A, and hence, the first user management unit 102 may obtain the current location of the vehicle 10 from the position information sensor 27 of the first user terminal 20A. The first user management unit 102 transmits the first user information (information on each of the first user ID, the vehicle ID, the current location, and the SNS account) to the center server 30 via the network N1 by means of the communication unit 36.

Now, the SNS server 40 will be described. The SNS server 40 is a server that manages the SNS. The SNS server 40 manages posting of users to the SNS, etc. The SNS server 40 can communicate with the first user terminal 20A, the second user terminals 20B, and the center server 30 via the network N1. The SNS server 40 stores, in the auxiliary storage unit 43, registration information about each user, posts of each user, places which each user has posted, the number of the social button pressed corresponding to each post, and the like. The SNS server 40 provides information on the SNS based on requests from the first user terminal 20A, the second user terminals 20B, and the center server 30.

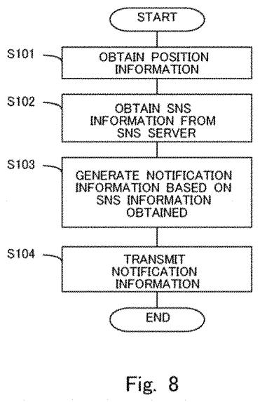

Next, provision processing will be described in which the center server 30 provides SNS information to each vehicle 10. FIG. 8 is a flowchart of the provision processing according to the present embodiment. The provision processing illustrated in FIG. 8 is repeatedly performed by the center server 30 for each vehicle 10 at predetermined time intervals. Here, note that the following explanation will be made on the assumption that necessary information has boon stored in the user information DB 311.

In step S101, the providing unit 303 obtains position information of a vehicle 10. Since the position information obtained from the vehicle 30 by the user information obtaining unit 301 has been stored in the user information DB 311, the providing unit 303 reads the position information which is the position information stored in the user information DB 311, and which corresponds to the vehicle 10. The providing unit 303 obtains the position information corresponding to the vehicle 30 based on the vehicle ID included in the first user information.

In step S102, the SNS information obtaining unit 302 obtains SNS information from the SNS server 40. The SNS information obtaining unit 302 accesses the SNS server 40, and extracts popular posting places. Further, the SNS information obtaining unit 302 obtains SNS information including information on popular posting places from the SNS server 40. Note that the information obtained from the SNS server 40 may be limited to, for example, SNS information in the case where the popular posting places are those places or locations which are included in the predetermined area from the current location of the vehicle 10. The SNS information obtaining unit 302 stores the SNS information thus obtained in the SNS information DB 312.

In step S103, the providing unit 303 generates notification information based on the SNS information obtained by the SNS information obtaining unit 302. The notification information includes, for example, a command to display an image related to a second user at a position corresponding to a popular posting place on a map displayed on the display 15 of the in-vehicle device 100. Since the SNS information obtained by the SNS information obtaining unit 302 from the SNS server 40 has been stored in the SNS information DB 312, the providing unit 303 reads the SNS information stored in the SNS information DB 312. The providing unit 303 generates notification information corresponding to the popular posting places included in the SNS information. The notification information includes, for example, information on an SNS account of a second user who has first posted at a popular posting place, information or the description of the popular posting place, and information on the number of second users who have posted for the popular posting place or the number of a social button pressed. This notification information may include a command to display an icon or the like corresponding to the second user who has first posted at the popular posting place. Here, note that the notification information to be generated may be limited to, for example, notification information corresponding to the popular posting places included in the predetermined area from the current location of the vehicle 10. Then, in step S104, the providing unit 303 transmits the notification information to the in-vehicle device 100 of the vehicle 10.

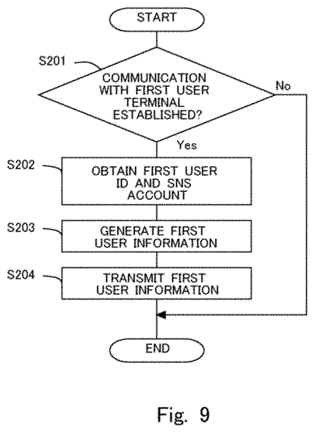

Next, the processing performed by the first user management unit 102 in the in-vehicle device 100 will be described. FIG. 9 is a flowchart of the processing of the first user management unit 102 according to the present embodiment. The processing or routine illustrated in FIG. 9 is repeatedly executed by the in-vehicle device 100 at predetermined time intervals.

In step S201, the first user management unit 102 determines whether short-range wireless communication with the first user terminal 20A has been established. In cases where an affirmative determination is made in step S201, the processing proceeds to step S202, whereas in cases where a negative determination is made, this routine is ended. In step S202, the first user management unit 102 obtains the first user ID and the SNS account of the first user from the first user terminal 20A.

Subsequently, in step S203, the first user management unit 102 generates first user information. The first user management unit 102 generates the first user information based on the first user ID and the SNS account obtained from the first user terminal 20A, the current location detected by the position information sensor 17, and the vehicle ID stored in the auxiliary storage unit 13. Then, in step S204, the first user management unit 102 transmits the first user information thus generated to the center server 30.

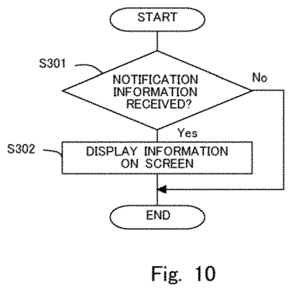

Now, the processing of the navigation unit 101 in the in-vehicle device 100 will be described. FIG. 10 is a flowchart of the processing performed by the navigation unit 101 according to the present embodiment. The processing illustrated in FIG. 10 is repeatedly performed by the in-vehicle device 100 at predetermined time intervals.

In step S301, the navigation unit 101 determines whether notification information has been received from the center server 30. In cases where an affirmative determination is made in step S301, the processing proceeds to step S302, whereas in cases where a negative determination is made, this routine is ended. In step S302, the navigation unit 101 displays the popular posting places on the map displayed on the display 15.

At this time, for example, a thumbnail of an image related to each popular posting place, or an account, icon, or avatar of a second user may be displayed on the map. In addition, when the first user taps an icon or the like displayed on the display 15, a post or an image corresponding to the tapped position may be displayed on the display 15, or an explanation corresponding to the tapped position may be displayed on the display 15. Such an instruction or command is generated by the center server 30, and transmitted from the center server 30 together with the notification information.

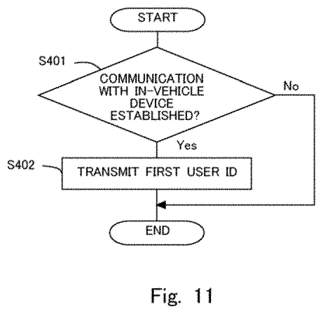

Next, the processing performed by the SNS account transmission unit 202 in the first user terminal 20A will be described. FIG. 11 is a flowchart of the processing of the SNS account transmission unit 202 according to the present embodiment. The processing illustrated in FIG. 11 is repeatedly executed by the first user terminal 20A at predetermined time intervals. Here, note that the following explanation will be made on the premise that the first use ID and the SNS account of the first user have been stored in the auxiliary storage unit 23 of the first user terminal 20A.

In step S401, the SNS account transmission unit 202 determines whether short-range wireless communication with the in-vehicle device 100 has been established. In cases where an affirmative determination is made in step S401, the processing proceeds to step S402, whereas in cases where a negative determination is made, this routine is ended. In step S402, the SNS account transmission unit 202 transmits the first user ID and the SNS account of the first user to the in-vehicle device 100.

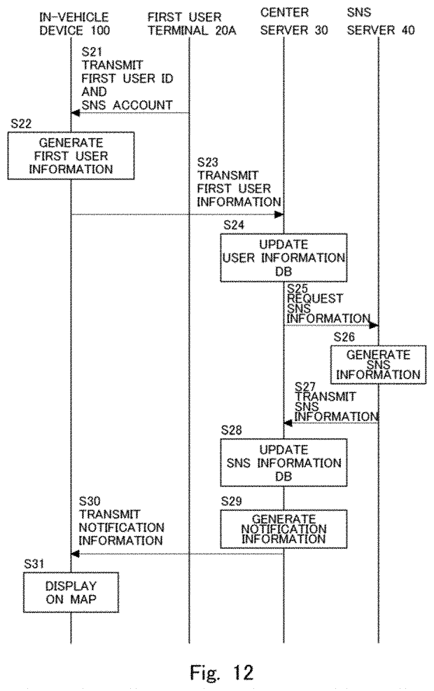

Next, the overall processing of the system 1 will be described. FIG. 12 is a sequence diagram illustrating the overall processing of the system 1. Here, note that in FIG. 12, it is assumed that position information is transmitted from the in-vehicle device 100 of the vehicle 10 at any time. Also, the following explanation will be made on the assumption that posts from the user terminal. 20 to the SNS have been stored in the SNS server 40.

When the first user gets in the vehicle 10, communication between the first user terminal 20A and the in-vehicle device 100 is established, and the first user ID and the SNS account of the first user are transmitted from the first user terminal 20A to the in-vehicle device 100 (S21). Then, in the in-vehicle device 100, first user information is generated (S22), and the first user information thus generated is transmitted to the center server 30 (S23). In the center server 30 that has received the first user information, the user information DB 311 is updated (S24). In addition, the center server 30 requests the SNS server 40 for SNS information on popular posting places (S25). The SNS server 40, which has received the request for the SNS information, generates the SNS information of the popular posting places (S26), and transmits the SNS information to the center server 30 (S27). The center server 30, which has received the SNS information, updates the SNS information DB 312 (S28). Then, the center server 30 generates notification information based on the SNS information (S29). The notification information thus generated is transmitted from the center server 30 to the in-vehicle device 100 (S30), so that the in-vehicle device 100 receiving the notification information displays the popular posting places on the map displayed on the display (S31).

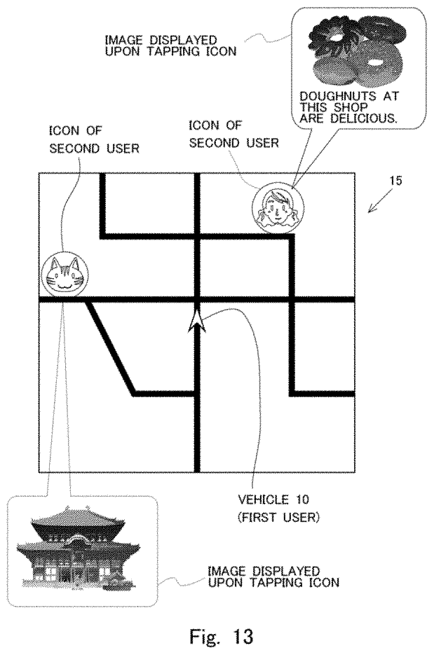

FIG. 13 is a view illustrating an example of the map displayed on the display 15 of the in-vehicle device 100. FIG. 13 illustrates the example in which popular posting places are displayed on the map based on the notification information transmitted from the center server 30. A road map of a predetermined area around the vehicle 10 is displayed on the display 15, and an icon of the vehicle 10 is indicated substantially at the center thereof. Icons corresponding to the SNS accounts of second users, respectively, are displayed at positions or locations corresponding to popular posting places. By viewing the information displayed on the display 15 in this way, the first user can know the popular posting places on the map. Then, when the first user taps an icon of a second user displayed on the display 15, a content (e.g., an image or text) posted by the second user is displayed.

As described above, according to the present embodiment, places popular in an SNS is displayed on a map, so that a first user can visually recognize the places, thus making it possible to prevent the first user from passing the place without noticing it.

### Other Embodiments

The above-described embodiment is merely an example, and the present disclosure can be appropriately modified and implemented without departing from the gist thereof.

The processing and means (devices, units, etc.) described in the present disclosure can be freely combined and implemented as long as no technical contradiction occurs.

In addition, the processing described as being performed by a single device or unit may be shared and performed by a plurality of devices or units. Alternatively, the processing described as being performed by different devices or unite may be performed by a single device or unit. In a computer system, it is possible to flexibly change the hardware configuration (server configuration) that can achieve each function of the computer system. For example, the center server 30 may include a part or all of the functions of the SNS server 40. Also, for example, the SNS server 40 may include a part or all of the functions of the center server 30.

In the above-described embodiment, an example has been described in which the center server 30 functions as an information processing apparatus, but the present invention is not limited thereto, and the in-vehicle device 100 may function as an information processing apparatus, or the first user terminal 20A may function as an information processing apparatus. In addition, any two or more of the center server 30, the in-vehicle device 100, and the first user terminal 20A may function as an information processing apparatus. For example, in the above-described embodiment, the center server 30 includes, as its functional components, the user information obtaining unit 301, the SNS information obtaining unit 302, the providing unit 303, the user information DB 311, the SNS information DB 312, and the map information DB 313, but the in-vehicle device 100 may include a part or all of these functional components. Also, the first user terminal 20A may be a terminal mounted on the vehicle 10.

Moreover, in the above-described embodiment, the in-vehicle device 100 obtains an SNS account from the first user terminal 20A, but the vehicle ID and the NS account of the first user may have been associated with each other in advance. In this case, the in-vehicle device 100 and the first user terminal 20A do not need to communicate with each other. For example, when the vehicle 10 is started, the SNS account of the first user may be transmitted from the in-vehicle device 100 to the center server 30. Also, the relation between the vehicle ID and the SNS account of the first user may have been stored in the center server 30 in advance, and when the vehicle 10 is activated, the in-vehicle device 100 may transmit information on the activation of the vehicle 10 to the center server 30. Then, the center server 30 may obtain the SNS account of the first user based on the vehicle ID.

Further, in the above-described embodiment, when the first user taps an icon or the like of a second user indicating a popular posting place, information on the popular posting place is displayed, but such display is not indispensable. Information showing a popular posting place may be simply displayed on the map.

Furthermore, in the above-described embodiment, an example has been described in which the first user uses an SNS, but the first user does not necessarily need to use an SNS. For example, the center server 30 may transmit a command to the in-vehicle device 100 so as to display popular posting places in a predetermined SNS on a map. In this case, the first user terminal 20A is not required.

The present disclosure can also be realized by supplying to a computer a computer program in which the functions described in the above-mentioned embodiment are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read only memory (ROM), a random access memory (RAM), an EPROM, an EEPROM, a magnetic card, a flash memory, an optical card, or any type of medium suitable for storing electronic commands or instructions.

What is claimed is:

1. An information processing apparatus including a control unit configured to perform:
obtaining information on a place having a degree of popularity equal to or greater than a predetermined threshold value in a social networking service; and
transmitting, to a vehicle with a display in which a first user gets, a command to display the place having a degree of popularity equal to or greater than the predetermined threshold value on a map displayed on the display of the vehicle.

2. The information processing apparatus according to claim 1, wherein
the display of the vehicle is a part of the navigation system; and
the control unit transmits, to the navigation system of the vehicle, a command to display the place having a degree of popularity equal to or greater than the predetermined threshold value on a map which is displayed on the display of the navigation system and which performs route guidance.

3. The information processing apparatus according to claim 1, wherein
the control unit obtains, as the information on the place having a degree of popularity equal to or greater than the predetermined threshold value, information on a place for which a first predetermined number or more of positive reactions have been recorded.

4. The information processing apparatus according to claim 1, wherein
the control unit obtains, as the information on the place having a popularity equal to or greater than the predetermined threshold value, information on a place for which a second predetermined number or more of posts have been made.

5. The information processing apparatus according to claim 1, wherein
the control unit transmits, to the vehicle, a command to display, at a position corresponding to the place having a degree of popularity equal to or greater than the predetermined threshold value on the map displayed on the display, an image related to a second user who has made a post about the place having a degree of popularity equal to or greater than the predetermined threshold value.

6. The information processing apparatus according to claim 5, wherein
the control unit transmits, to the vehicle, a command to display on the display a content of the post, made by the second user about the place having a degree of popularity equal to or greater than the predetermined threshold value, in cases where the first user has selected the place having a degree of popularity equal to or greater than the predetermined threshold value on the map displayed on the display.

7. The information processing apparatus according to claim 1, wherein
the control unit obtains a current location of the vehicle, and transmits, to the vehicle, a command to display those places which are located in a predetermined area from the current location of the vehicle and have a degree of popularity equal to or greater than the predetermined threshold value, as the command to display the place having a degree of popularity equal to or greater than the predetermined threshold value.

8. The information processing apparatus according to claim 1, wherein
the control unit obtains information on a position at which a post about the place having a degree of popularity equal to or greater than the predetermined threshold value has been made, and specifies the place having a degree of popularity equal to or greater than the predetermined threshold value based on the information on the position at which the post has been made.

9. A non-transitory storage medium with a program stored therein, the program being configured to cause a computer to perform:
obtaining information on a place having a degree of popularity equal to or greater than a predetermined threshold value in a social networking service; and
transmitting, to a vehicle in which a first user gets, a command to display the place having a degree of popularity equal to or greater than the predetermined threshold value on a map displayed on a display of the vehicle.

10. The non-transitory storage medium with a program stored therein according to claim 9, wherein
the display of the vehicle is a part of a navigation system of the vehicle; and
the program is configured to cause the computer to transmit, to the navigation system of the vehicle, a command to display the place having a degree of popularity equal to or greater than the predetermined threshold value on a map which is displayed on the display of the navigation system and which performs route guidance.

11. The non-transitory storage medium with a program stored therein according to claim 9, wherein
the program is configured to cause the computer to obtain, as the information on the place having a degree of popularity equal to or greater than the predetermined threshold value, information on a place for which a first predetermined number or more of positive reactions have been recorded.

12. The non-transitory storage medium with a program stored therein according to claim 9, wherein
the program is configured to cause the computer to obtain, as the information on the place having a degree of popularity equal to or greater than the predetermined threshold value, information on a place for which a second predetermined number or more of posts have been made.

13. The non-transitory storage medium with a program stored therein according to claim 9, wherein
the program is configured to cause the computer to transmit, to the vehicle, a command to display, at a position corresponding to the place having a degree of popularity equal to or greater than the predetermined threshold value on the map displayed on the display, an image related to a second user who has made a post about the place having a degree of popularity equal to or greater than the predetermined threshold value.

14. The non-transitory storage medium with a program stored therein according to claim 13, wherein
the program is configured to cause the computer to transmit, to the vehicle, a command to display on the display a content of the post made by the second user about the place having a degree of popularity equal to or greater than the predetermined threshold value, in cases where the first user has selected the place having a degree of popularity equal to or greater than the predetermined threshold value on the map displayed on the display.

15. The non-transitory storage medium with a program stored therein according to claim 9, wherein
the program is configured to cause the computer to obtain a current location of the vehicle, and to transmit, to the vehicle, a command to display those places which are located in a predetermined area from the current location of the vehicle and have a degree of popularity equal to or greater than the predetermined threshold value, as the command to display the place having a degree of popularity equal to or greater than the predetermined threshold value.

16. The non-transitory storage medium with a program stored therein according to claim 9, wherein
the program is configured to cause the computer to obtain information on a position at which a post about the place having a degree of popularity equal to or greater than the predetermined threshold value has been made, and to specify the place having a degree of popularity equal to or greater than the predetermined threshold value based on the information on the position at which the post has been made.

17. A system comprising:
a vehicle in which a first user gets, the vehicle including a display capable of displaying a map; and
a server including a control unit configured to perform:
obtaining information on a place having a degree of popularity equal to or greater than a predetermined threshold value in a social networking service; and
transmitting, to the vehicle, a command to display the place having a degree of popularity equal to or greater than the predetermined threshold value on the map displayed on the display.

18. The system according to claim 17, wherein
the display of the vehicle is a part of a navigation system of the vehicle; and
the control unit transmits, to the navigation system of the vehicle, a command to display the place having a degree of popularity equal to or greater than the predetermined threshold value on a map which is displayed on the display of the navigation system and which performs route guidance.

19. The system according to claim 17, wherein
the control unit obtains, as the information on the place having a degree of popularity equal to or greater than the predetermined threshold value, information on a place for which a first predetermined number or more of positive reactions have been recorded.

20. The system according to claim 17, wherein
the control unit obtains, as the information on the place having a popularity equal to or greater than the predetermined threshold value, information on a place for which a second predetermined number or more of posts have been made.
